(19) United States
(12) Patent Application Publication
(10) Pub. No.: US 2021/0125584 A1
(43) Pub. Date: Apr. 29, 2021

(54) AVATAR GROUP CONTROL CONCEPT

(71) Applicant: SAP SE, Walldorf (DE)

(72) Inventors: Sabina Hitzler, Heidelberg (DE); Anke Debatin, Hambrücken (DE)

(21) Appl. No.: 16/665,922

(22) Filed: Oct. 28, 2019

(51) Int. Cl. G09G 5/37

(52) U.S. Cl. CPC G09G 5/37; G09G 2320/10; G09G 2340/145; G09G 2354/00

(57) ABSTRACT

The present disclosure also provides one or more non-transitory computer-readable storage media coupled to one or more processors and having instructions stored thereon which, when executed by the one or more processors, cause the one or more processors to perform operations in accordance with implementations of the methods provided herein. One method includes identifying a group of individuals who represent members of a group and generating an individual avatar for each individual in the group. A composite avatar can be generated for display on a user computing device, where the composite avatar represents all of the individuals in the group. The composite avatar can display a subset of the individual avatars and an overflow icon. The subset of individual avatars can be selected based on the available screen space, or the total number of individuals in a group.

### BACKGROUND

Avatars can be used to provide an identifier representing one or more users. A set of avatars can be generally presented together to visually showcase a team, project team members, or employees, for example.

### SUMMARY

The present disclosure also provides one or more non-transitory computer-readable storage media coupled to one or more processors and having instructions stored thereon which, when executed by the one or more processors, cause the one or more processors to perform operations in accordance with implementations of the methods provided herein. A first example method includes identifying a group of individuals who represent members of a group or team, and generating an individual avatar for each individual in the group or team. Secondary information related to each individual is associated with each individual avatar. A composite avatar can be generated for display on a user computing device, where the composite avatar represents all of the individuals in the group. The composite avatar can display a subset of the individual avatars and an overflow icon that displays a number representing the members of the group not displayed in the subset of individual avatars. The subset of individual avatars can be selected based on the available screen space, or the total number of individuals in a group. The composite avatar can by dynamically updated based on a detected change in available screen space or a change in membership of the group.

Implementations can optionally include one or more of the following features.

In some instances, the individual avatars are one of, a circular image related to the individual the avatar represents, the individual's initials, or a gender neutral person icon representing the individual.

In some instances, the subset of individual avatars displayed in the composite avatar is displayed in an order based on the name of each individual (e.g., alphabetically), or a relative seniority, or a group role of each individual. The subset of individual avatars can be dynamically updated if a change is detected in any of the factors used to determine the order.

In some instances, when the available screen area is reduced, the composite avatar is dynamically updated by reducing the number of individual avatars displayed in the subset, and increasing the number displayed on the overflow icon. In another instance, if the available screen area is increased, the number of individual avatars displayed in the subset can be increased, and the number presented on the overflow icon reduced.

In some instances, in response to detecting a change in group membership, the overflow icon can be dynamically updated to display an updated number.

In some instances secondary information associated with each individual avatar can be an email address, a user ID, an office location, a phone number, a mailing address, or a group role.

In some instances in response to a user clicking or tapping on the composite avatar, a new page is opened that displays some or all of the secondary information associated with the individual avatars in the group.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example environment that can be used to execute implementations of the present disclosure.

FIGS. 2A-2C depict an example individual avatar display and functionality.

FIGS. 3A-3C depict an example composite avatar display and functionality.

FIG. 4 depicts an example process for displaying a group.

FIG. 5 is a schematic illustration of example computer systems that can be used to execute implementations of the present disclosure.

### DETAILED DESCRIPTION

Implementations of the present disclosure include computer-implemented systems and methods for presenting groups of individuals in a user interface (UI) that provide consistent user experiences (UX) across many different potential client devices and device configurations. For example, a user may want to be presented with a group display depicting each member of their team who shares a manager. This group may be displayed on a small device such as a smartphone or the group may be displayed on a PC with a much larger display. A consistent UX is required regardless of the available screen area.

Some implementations of the present disclosure include generating two types of avatars for display. One type of avatar can be an individual avatar that is associated with only a single person. A second type of avatar can be a composite avatar, which can be a composite of a plurality of individual avatars.

An individual avatar can be, for example, a circular image showing a portrait of the individual, or if an image is not available, the individual's initials. In another implementation the avatar can be a gender neutral graphic representing a person.

A composite avatar can be a plurality of individual avatars presented as a cluster, or partially overlapped. In some implementations, the composite avatar displays a portion of the individual avatars of the group and an overflow indicator or icon representing the remaining individuals in the group.

By way of a non-limiting example, if a group contains 28 members, the composite avatar can be presented as a row of disks, with three individual avatars presented and a single overflow icon displaying a “+25” image indicating there are 25 more members who are not shown. As another example, if there is more available screen area, the composite avatar can display eight individual avatars, and the overflow icon displays “+20” instead.

The composite avatar can dynamically adapt in size to provide the user with a consistent UX, or easy to consume avatar information using a user friendly visualization. For example, if the user resizes a window in which the composite avatar is displayed, the composite avatar can automatically adjust to provide appropriate information while maintaining an appropriate portion of the available screen area.

Further, even without changes in the group, the composite avatar may be dynamically adapted as to its internal presentation of particular group members. In some instances, the composite avatars may be organized based on name, role, relative seniority, or level of interaction with the user, among others. Should any information change with regard to one or more of the persons in the group, then the presentation of the composite avatar may be updated dynamically or in response to an event. For example, if a user interacts with a particular member of the group in a separate interaction, the composite avatar may be updated upon such detection to provide an illustration that a recently-interacted person is included in the group. Alternatively, a business or interaction reason for presenting the composite avatar may cause the order to be shifted, such as when a particular group member is comparatively more relevant to a particular presentation. By presenting that person (e.g., a specialist member of the IT team), may be presented earlier in the composite avatar including IT team members when the reason for the presentation of the composite avatar relates to that specialist member's role or expertise.

Each individual avatar can be associated with additional information about the individual represented by the avatar. This additional information can include, but is not limited to, a full or partial name, date of birth, job title or role, manager, associated team members, contact information, an ID number, or any combination or subcombination thereof. Alternative and/or other additional information may be associated with the individual avatars. Each individual avatar may also have a relevance score associated with the individual and the user viewing the avatar. The relevance score may be based on, for example, number of recent interactions, the user role and the individual's role, or manually inputted preferences or relationships. Additionally, each composite avatar can have additional information associated with the group. For example, a group type, a member seniority for each member of the group, a contact list, or other metadata associated with the group can be associated with the group itself, as well as a group email or communication list, web page, or other contact information.

In some instances, when the composite avatar only displays a portion of the entire group, the portion can be selected based on seniority, on an alphabetical ordering by name, on a relevance score associated with the user, or any suitable factors, including a combination or subcombination thereof.

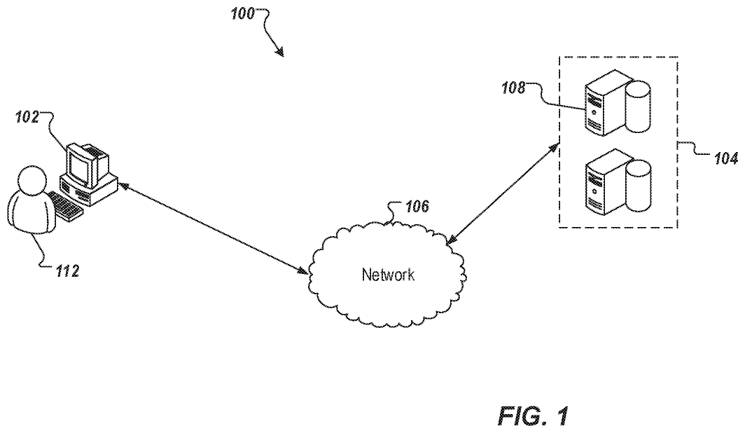

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices, and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provide such services to any number of client devices (e.g., the client device 102 over the network 106).

In accordance with implementations of the present disclosure, the server system 104 can host an enterprise application or set of enterprise applications that the user 112 can access via the client device 102. The UI and UX are provided on the client device 102 by the server system 104, via the network 106.

In some instances, multiple users will access an enterprise application in order to work collaboratively on the server 104. In these instances, the users may want to interact with one or more team members or simply determine which users are on which teams or details about a particular user on a particular team. The user 112 can access a composite avatar at the client device 102 which can present some or all of the members in a particular group or team and additional information associated with the group or the individuals in the group. In some instances, batch operations associated with the group can be provided to be performed by the user.

For example, a manager of a software development team can view a composite avatar showing a subset of the members of the software development team and an overflow icon indicating the members not shown. The manager can activate (e.g., click on, tap, or otherwise select) the composite avatar and a pop-up window can appear that displays additional information about some or all of the members of the group. In the pop-up window, there can be additional input options, for example, the pop-up window can display individual avatars, and, in response to a click or tap on an individual avatar, the manager can be presented with details associated with that individual. In another instance, a selection for an input associated with all or some of the team members can be provided, such as approving pay or bonuses, or sending an email to the entire team.

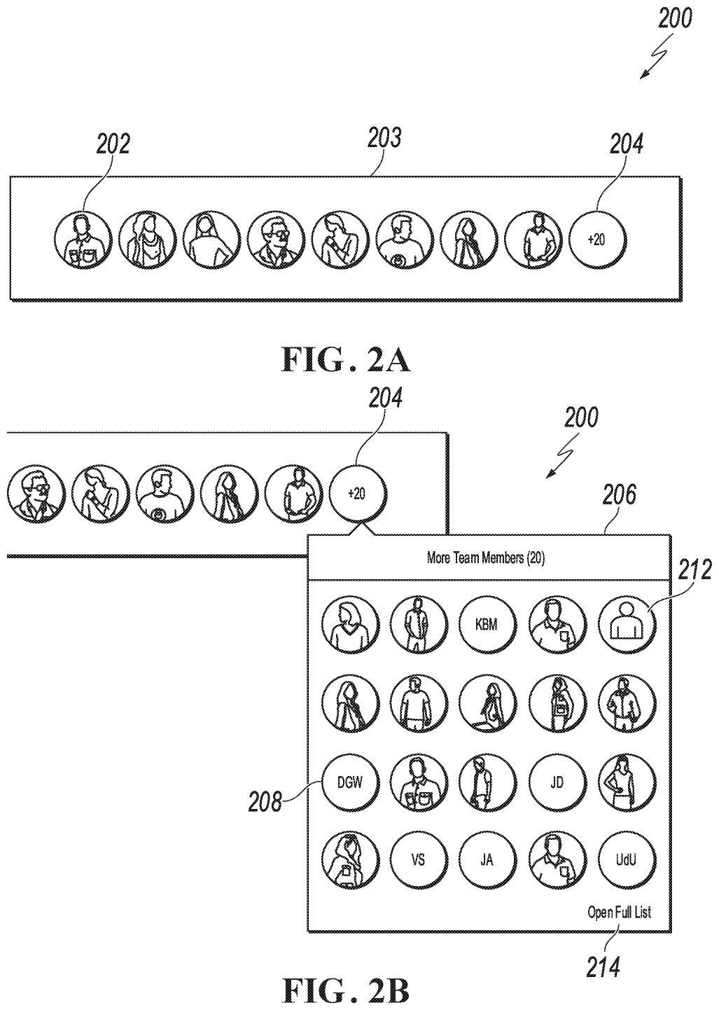

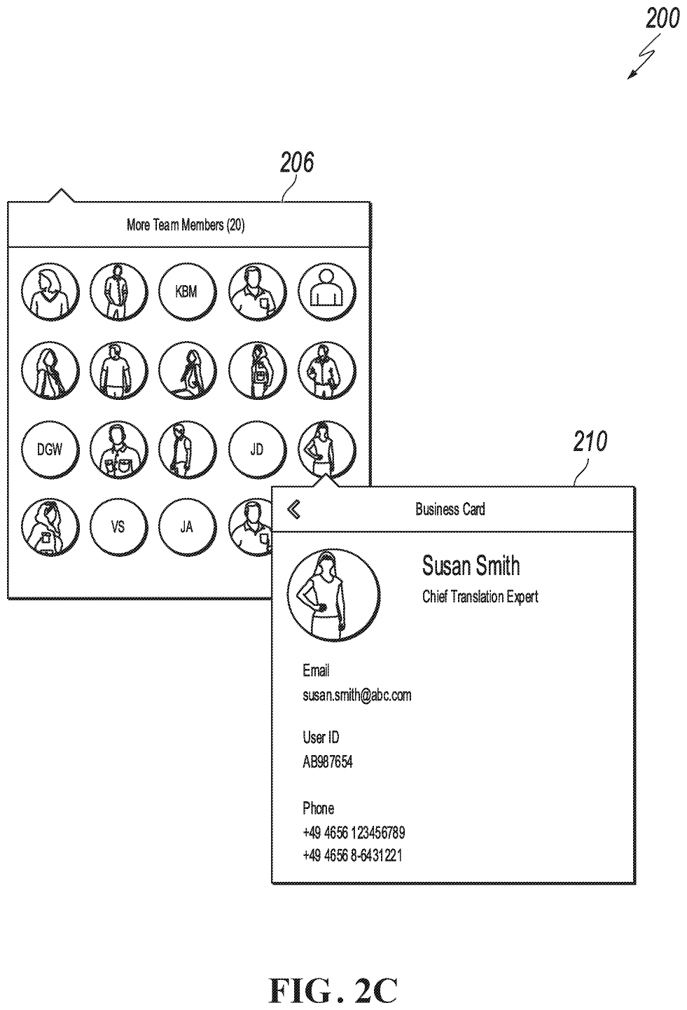

FIGS. 2A-2C depict an example display 200 of individual avatars and corresponding functionality. In FIG. 2A the individual avatars 202 can be presented in a row, column, or grid, or any suitable orientation. The example shown in FIG. 2A has the individual avatars arranged in a row 203. In some implementations, each avatar has a circular shape and is a unique representation of the individual with which the avatar is associated. The avatar can be represented as an image, such as a photograph of the individual's face that allows a user to quickly identify the individual associated with the avatar.

An overflow icon 204 can be presented when there is not enough available screen area to display all individual avatars 202 within the presentation area. The overflow icon 204 can be a circle of similar size to the individual avatar 202, and can display a number of remaining avatars instead of an image or initials. For example, if a particular organization has 28 individuals and 28 individual avatars, but there is only space for nine avatars to be displayed on the available screen area, eight individual avatars can be displayed along with the overflow icon 204 showing “+20” being displayed in the ninth available space. As shown in FIG. 2B, if the user activates (e.g., clicks or taps) on the overflow icon 204, an additional list window 206 can be presented to obtain additional information or illustration of the other group members.

The list window 206 can present a larger selection of individual avatars which can be sorted by various means. For example, the list window 206 can provide a grid view of individual avatars, which is sized based on the available screen space, and can present the user with avatars. The order of presentation of the avatars can be based on a comparison of relevance scores, an alphabetical order or listing of individuals, relative role-based ordering, a listing based on relative seniority, or any other suitable criteria. The list window 206 can include a link or button that allows the user to access a complete list of individual avatars (214).

In some implementations, the individual avatar can be a colored circle with the individual's initials 208 or a gender neutral icon representing an individual 212 when a photo is not available. The color can be a randomly selected color, a color selected by the individual, a color selected by a backend server or computing device to be consistent with a theme selected by a user or to illustrate some additional information or category of individual, or any other color selection process or scheme. Each individual avatar can have a unique click or tap area defined by the size or shape of the individual avatar. As shown in FIG. 2C, in response to a user activating (e.g., clicking, tapping, or focusing and selecting) an avatar, that individual's business card 210 can be presented. The business card 210 can show additional information associated with the individual, such as the individual's full name, position or role, email address, user ID, phone numbers, relevance score associated with the user, or other details that might be pertinent or available to a user interacting with the avatars.

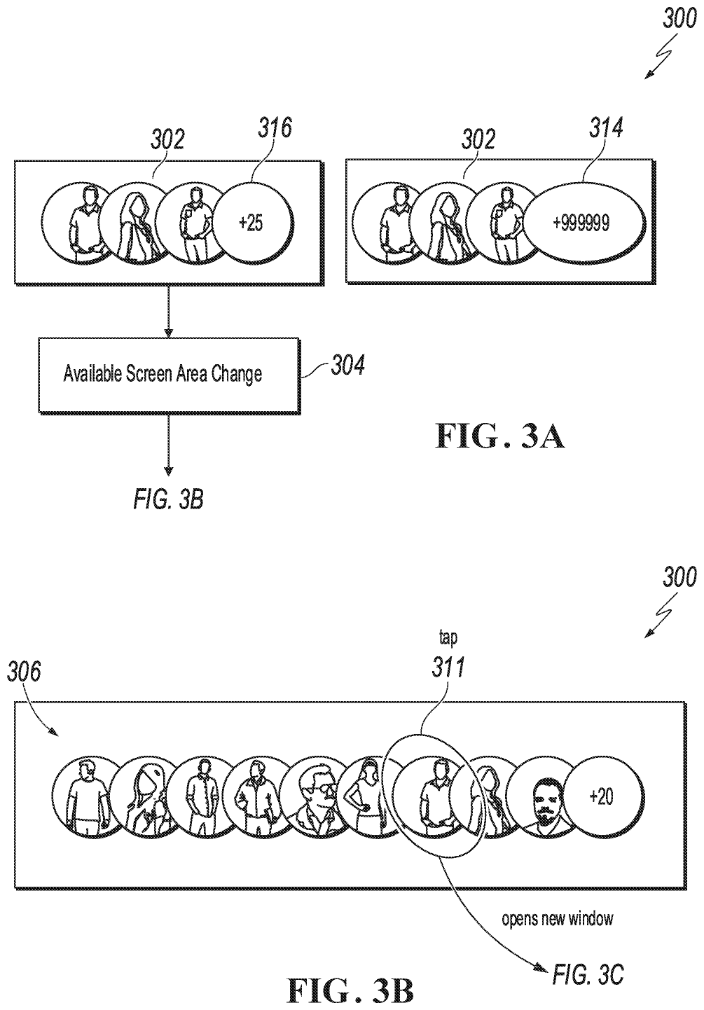

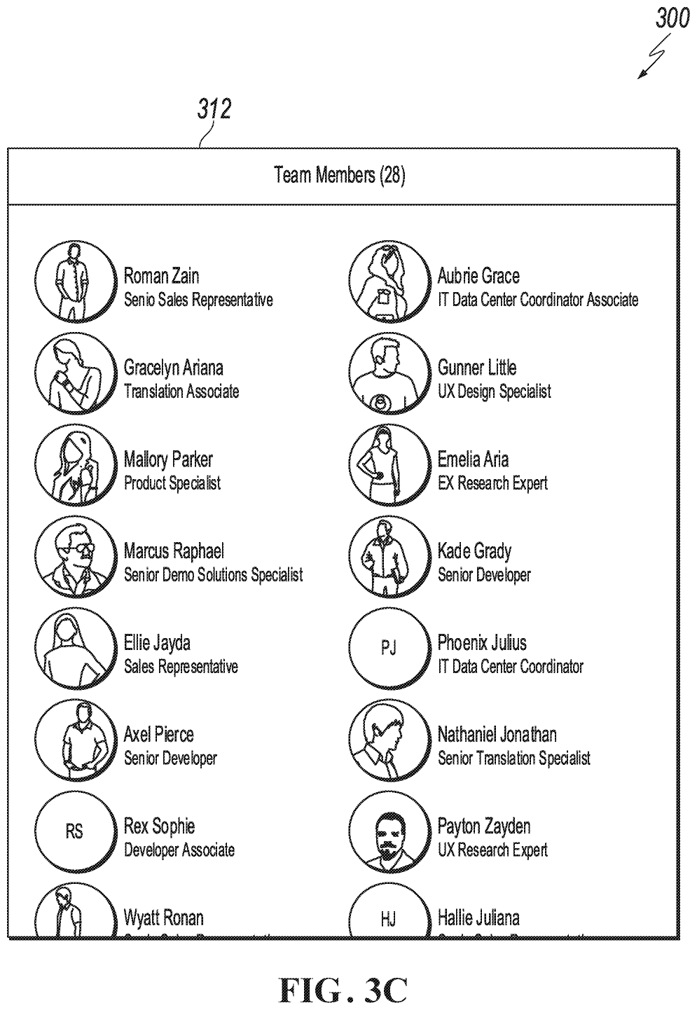

FIGS. 3A-3C depict an example of a composite avatar display 300 and an illustrated example set of functionality associated therewith. As shown in FIG. 3A the composite avatar 302 can be presented as a row, a column, or a disk, or any suitable form for a given available screen area. The composite avatar 302 can be generated by displaying one or more individual avatars in an overlapping fashion, with an overflow icon 316 similar to the overflow icon described with reference to FIG. 2A.

The overflow icon 316 can display a number and indicate the members of the group not displayed on the composite avatar. As depicted in FIG. 3A, the overflow icon can be presented on the right end of the composite avatar. In another implementation, the overflow icon 316 can be presented on the left, or top, bottom, or other suitable location. In some implementations, the overflow icon 316 can be dynamically expandable to allow for display of larger number (314).

FIGS. 3A-3C are distinguishable from FIGS. 2A-2C in that the avatars in FIGS. 2A-2C are shown as separate, individual avatars with separate and individual controls for each avatar. In FIGS. 3A-3C, the composite avatar 302 is associated with and has group control functionality for the group and not an individual avatar. In some instances, the individual avatars may not be overlapping in the composite avatar 302, but may still be treated as a single unit within the composite avatar 302. The number of individual avatars displayed in the composite avatar can be dependent on the available screen area, as well as user preferences, among other factors.

In one example, if the available screen area changes 304 (e.g., the window is increased in size, the user disconnects a monitor from a mobile device, or the user switches from a full screen mode to a split screen mode, etc.) the composite avatar 302 can dynamically update to the composite avatar 306 as depicted in FIG. 3B. In this example, the composite avatar, which includes 28 members, initially displays a subset of three of the members, with an overflow icon indicating a “+25” for the remaining members. When the available screen area increases, the composite avatar can update to displaying a subset of eight individual avatars and the overflow icon can display “+20” indicating the members not shown (306).

The subset of individual avatars chosen to be displayed within the composite avatar can be based on seniority, or alphabetical by name, or based on a relevance score associated with the user, or any suitable combination thereof. In some implementations, the subset can be based on a manual input from a user or a sorting criteria. For example, if a user is accessing a group to provide approvals to some or all of the members of the group, the subset may be chosen exclusively from group members who currently require one or more approvals. In another implementation, a group leader or manager is always presented as a member of the subset of individuals to be displayed.

The composite avatar (306 or 302) can represent a single selectable area. For example, a user can click or tap (311) anywhere within the composite avatar 306 and the result will be the same. In response to a click or tap, or otherwise receipt of a selection of the composite avatar (311), a group member page can be opened (312) as shown in FIG. 3C. The group member page 312 shows a list of members of a group. In some instances, the group member page 312 displays the individual avatars for each member of the group as well as some additional information, for example, full name, job title, email address, and/or any other suitable information or details.

If the user then selects and activates (e.g., clicks or taps on) the individual avatar in the group member page they can be presented with additional details such as, for example, a business card similar to that described with reference to FIG. 2C.

The group member page 312 may also include additional controls (not shown), for example, an “email all” button or filter buttons, to allow the user to interact with the group in a more efficient manner. For example, in a group where some or all the members are awaiting approval from a user, the user can be presented with an “approve all” button which allows the user to perform bulk approvals for specific groups of individuals.

The composite avatar can conform to standard keyboard shortcuts within its current operating environment. For example, if the user is in a Windows environment and presses the TAB button on a keyboard, the composite avatar can be highlighted or selected, and upon an additional press of the TAB button, the next element on the page can be highlighted or selected. If the composite avatar is highlighted or selected, and the user presses ENTER, the composite avatar can open the group member page 312, similarly as if it were clicked or tapped on.

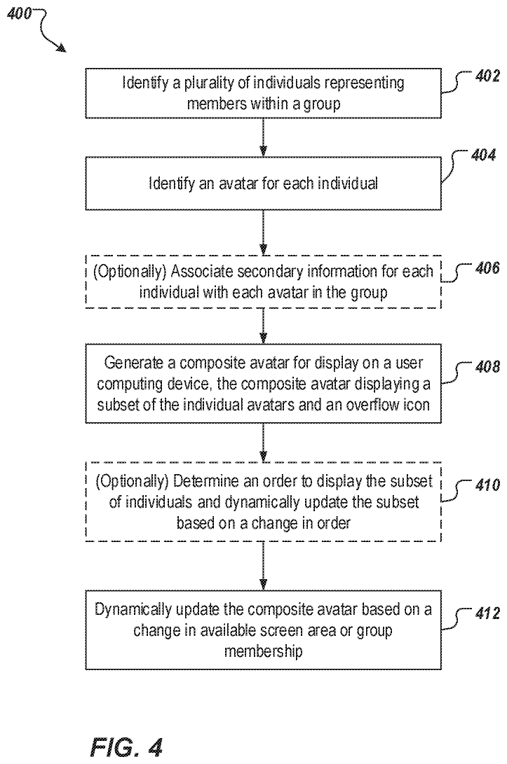

FIG. 4 depicts an example process 400 that can be executed in accordance with implementations of the present disclosure. In some implementations, the example process 400 may be performed using one or more computer-executable programs executed using one or more computing devices.

At 402, a plurality of individuals are identified that represent members of a group. For example, a work project may be split into several teams, each team having a plurality of members that form a group. The team may include members of differing seniority (e.g., manager, team leader, intern, etc.) and different roles (e.g., software engineer, IT specialist, communications director, etc.), among other possible distinctions.

At 404, an avatar is generated or obtained for each individual in the group. The individual avatars can be, for example, a circular profile picture or an image representing the individual. In some instances, the individual avatar can be the individual avatar as described with reference to FIG. 2.

At 406, secondary information associated with each individual is associated with each generated individual avatar. The secondary information can be, but is not limited to, the individual's full name, position or role, seniority, email address, user ID, phone numbers, or a relevance score associated with the user. In some instances, the secondary information is already included with the obtained individual avatars in 404.

At 408, a composite avatar is generated for display on a user computing device. The user computing device can be, but is not limited to, a PC, tablet, smartphone, laptop, or other suitable computing device configured with a display. In some implementations, the composite avatar can be similar to the composite avatar as described with respect to FIG. 3. The composite avatar includes a subset of the individual avatars chosen from the members of the group. The subset can be selected based on the individual's name (e.g., alphabetically), a relative seniority level, a group role, or a relevance score associated with the user. The number of individuals in the subset can be determined based on the available screen area the composite avatar will be displayed in. For example, on a PC with a large window, the subset may contain eight individual avatars. In another example, when presented on a smartphone, with less available screen area than the PC, the subset may only contain three individual avatars.

The composite avatar also includes an overflow icon, which can display a number representing the members of the group that are not presented with the subset. For example, if the entire group has 28 members, and eight of the members are displayed with the subset, the overflow icon can indicated a “+20.” In some instances, the overflow icon is a circle of similar size to the individual avatars. In other instances, it can adjust in size to display a larger number, as described in an example with respect to FIG. 3.

Optionally at 410, the subset of individuals is displayed in a particular order determined based on one or more factors. The factors determining the order the subset is displayed in can be, but are not limited to individuals' names (e.g., alphabetically), a relative seniority level, a group role, or a relevance score associated with the user. If group membership changes, or the relevance score or other factors associated with the individuals in the group change, the order the subset is presented in can be dynamically updated, so the most pertinent, or relevant individuals are displayed in the subset.

At 412, in response to detecting a change in available screen area or a change in group membership, the composite avatar is dynamically updated. For example, if the user resizes the window displaying the composite avatar, the number of individuals presented in the subset may change, and the overflow icon may update accordingly to ensure the entire group is still represented. In another example, if a new member is added to the group, the overflow icon may update, indicating the group size has increased. In yet another example, if a member of the group is promoted to manager, that individual may be added to the subset.

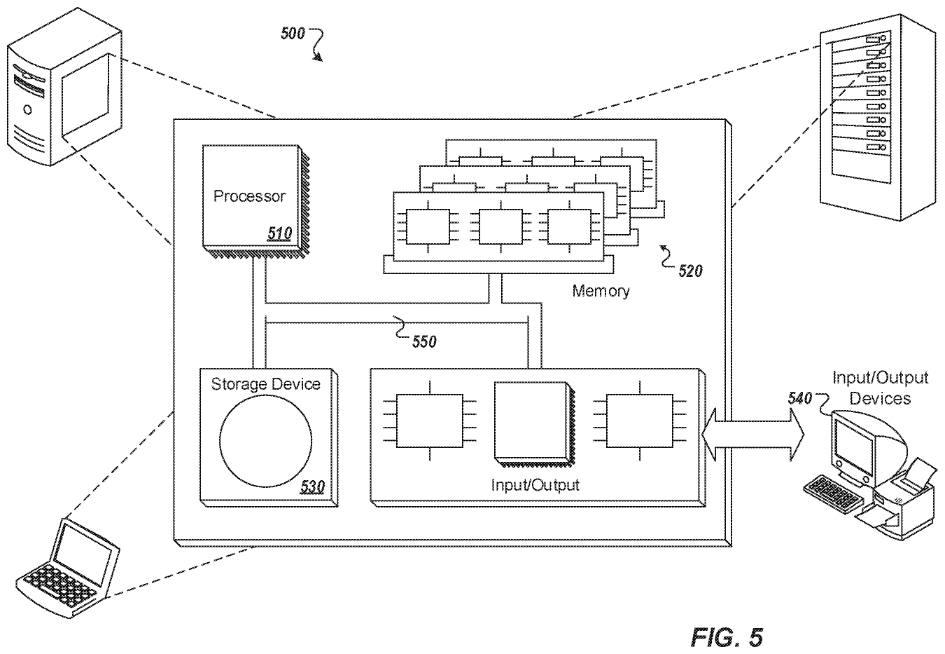

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, and 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a solid-state storage device, a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

Implementations of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively, or in addition, the carrier may be an artificially-generated propagated signal, e.g., a machine-generated electrical, optical, or electromagnetic signal that is generated to encode information for transmission to suitable receiver apparatus for execution by a data processing apparatus. The computer storage medium can be, or be part of, a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. Elements of a computer can include a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, implementations of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular implementations. Certain features that are described in this specification in the context of separate implementations can also be realized in combination in a single implementation. Conversely, various features that are described in the context of a single implementation can also be realized in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for displaying a group, the method comprising:
identifying a plurality of individuals representing members within a group;
identifying an individual avatar for each individual in the identified plurality of individuals;
generating a composite avatar for display on a user computing device, the composite avatar representing the plurality of individuals, the composite avatar displaying a subset of the individual avatars and an overflow icon displaying a number indicating members within the group that are not displayed in the subset of individual avatars in an overlapping manner, wherein the avatar for each individual displayed comprises at least one circular icon comprising a photographic image associated with the individual or a set of initials associated with the individual, and wherein the subset of individual avatars is based on:
available screen space; and
number of individuals in the group; and
in response to detecting a change in available screen area or group membership, dynamically updating the composite avatar based on the detected change.

2. (canceled)

3. The method of claim 1, wherein the subset of the individual avatars displayed within the composite avatar is initially presented in an order based on at least one of:
a relative seniority of each individual; or
a group role of each individual.

4. The method of claim 3, wherein detecting the change comprises detecting a change to the order, and dynamically updating the order the subset of individual avatars is presented in based on the detected change.

5. The method of claim 1, wherein dynamically updating the composite avatar comprises, in response to detecting a reduction in available screen area, reducing the number of individual avatars displayed in the subset and increasing the number displayed on the overflow icon.

6. The method of claim 1, wherein dynamically updating the composite avatar comprises, in response to detecting an increase in available screen area, increasing the number of individual avatars displayed in the subset and decreasing the number displayed on the overflow icon.

7. The method of claim 1, wherein in response to detecting a change in group membership, dynamically updating the composite avatar comprises updating the overflow icon.

8. The method of claim 1, wherein each individual avatar is associated with secondary information associated with each individual, and wherein the secondary information comprises:
an email address;
a user ID; and
a group role.

9. The method of claim 8, further comprising:
in response to a user selecting the composite avatar, opening a new page displaying at least a portion of the secondary information associated with each individual.

10. The method of claim 9, wherein the new page comprises an “email all” button that initiates an email associated with all members within the group.

11. A non-transitory computer-readable storage medium coupled to one or more processors and having instructions stored thereon which, when executed by the one or more processors, cause the one or more processors to perform operations for displaying a group, the operations comprising:
identifying a plurality of individuals representing members within a group;
identifying an individual avatar for each individual in the identified plurality of individuals;
generating a composite avatar for display on a user computing device, the composite avatar representing the plurality of individuals, the composite avatar displaying a subset of the individual avatars and an overflow icon displaying a number indicating members within the group that are not displayed in the subset of individual avatars in an overlapping manner, wherein the avatar for each individual displayed comprises at least one circular icon comprising a photographic image associated with the individual or a set of initials associated with the individual, and wherein the subset of individual avatars is based on:
available screen space; and
number of individuals in the group; and
in response to detecting a change in available screen area or group membership, dynamically updating the composite avatar based on the detected change.

12. (canceled)

13. The computer-readable medium of claim 11, wherein the subset of the individual avatars displayed within the composite avatar is initially presented in an order based on at least one of:
a relative seniority of each individual; or
a group role of each individual.

14. The computer-readable medium of claim 13, wherein detecting the change comprises detecting a change to the order, and dynamically updating the order the subset of individual avatars is presented in based on the detected change.

15. The computer-readable medium of claim 11, wherein dynamically updating the composite avatar comprises, in response to detecting a reduction in available screen area, reducing the number of individual avatars displayed in the subset and increasing the number displayed on the overflow icon.

16. The computer-readable medium of claim 11, wherein dynamically updating the composite avatar comprises, in response to detecting an increase in available screen area, increasing the number of individual avatars displayed in the subset and decreasing the number displayed on the overflow icon.

17. The computer-readable medium of claim 11, wherein in response to detecting a change in group membership, dynamically updating the composite avatar comprises updating the overflow icon.

18. The computer-readable medium of claim 11, wherein each individual avatar is associated with secondary information associated with each individual, and wherein the secondary information comprises:
an email address;
a user ID; and
a group role.

19. The computer-readable medium of claim 18, further comprising:
in response to a user selecting the composite avatar, opening a new page displaying at least a portion of the secondary information associated with each individual.

20. A system, comprising:
one or more computers; and
a computer-readable storage device coupled to the one or more computers and having instructions stored thereon which, when executed by the one or more computer, cause the one or more computers to perform operations for displaying a group, the operations comprising:
identifying a plurality of individuals representing members within a group;
identifying an individual avatar for each individual in the identified plurality of individuals, wherein each individual avatar comprises secondary information associated with each individual;
generating a composite avatar for display on a user computing device, the composite avatar representing the plurality of individuals, the composite avatar displaying a subset of the individual avatars and an overflow icon displaying a number indicating members within the group that are not displayed in the subset of individual avatars in an overlapping manner, wherein the avatar for each individual displayed comprises at least one circular icon comprising a photographic image associated with the individual or a set of initials associated with the individual, and wherein the subset of individual avatars is based on:
available screen space; and
number of individuals in the group; and
in response to detecting a change in available screen area or group membership, dynamically updating the composite avatar based on the detected change.
